(19) United States
(12) Patent Application Publication
(10) Pub. No.: US 2011/0287338 A1
(43) Pub. Date: Nov. 24, 2011

(54) LOW LEVEL CERIUM MITIGATION WITH ELECTRODE EDGE PROTECTION

(75) Inventor: Frank Coms, Fairport, NY (US)

(73) Assignee: GM GLOBAL TECHNOLOGY OPERATIONS, INC., Detroit, MI (US)

(21) Appl. No.: 12/784,920

(22) Filed: May 21, 2010

(51) Int. Cl. H01M 2/14; H01M 4/88

(52) U.S. Cl. 429/508; 502/4

(57) ABSTRACT

The fuel cell of this embodiment includes an ion conducting membrane having a first side and a second side. Characteristically, the ion conducting membrane has a sufficient amount of cerium ions to inhibit the loss of fluoride from the ion conducting membrane when compared to an ion conducting membrane having the same construction except for the presence of cerium ions. The MEA also includes a first catalyst layer disposed on the first side of the ion conducting layer and a second catalyst layer disposed on the second side of the ion conduction layer. A first gasket is disposed between the first catalyst layer and the first side of the ion conducting membrane along the periphery of the second side. Similarly, a second gasket is interposed between the second catalyst layer and the second side of the ion conducting membrane along the periphery of the second side.

### TECHNICAL FIELD

The present invention relates to fuel cell assemblies with improved resistance to chemical degradation, and in particular, to fuel cell assemblies with reduced loss of fluorine.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the catalyst of the fuel supply electrode. Each electrode has finely divided catalyst particles (for example, platinum particles), supported on carbon particles, to promote oxidation of hydrogen at the anode and reduction of oxygen at the cathode. Protons flow from the anode through the ion conductive polymer membrane to the cathode where they combine with oxygen to form water which is discharged from the cell. Typically, the ion conductive polymer membrane includes a perfluorinated sulfonic acid (PFSA) ionomer.

The MEA is sandwiched between a pair of porous gas diffusion layers (“GDL”) which in turn are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

One mechanism by which ion conducting polymer membranes degrade is via loss of fluorine (i.e., fluoride emission) under open circuit voltage (OCV) and dry operating conditions at elevated temperatures. Additives to PFSA membranes are required to improve fuel cell life, increase membrane durability and reduce fluoride emissions under these conditions.

Accordingly, there is a need for improved ion conducting membranes with reduced fluoride emissions.

### SUMMARY OF EXEMPLARY EMBODIMENTS OF THE INVENTION

The present invention solves one or more problems of the prior art by providing a fuel cell with improved fluoride retention. The fuel cell of this embodiment includes an ion conducting membrane having a first side and a second side. Characteristically, the ion conducting membrane has a sufficient amount of a stabilization agent (e.g., cerium containing compounds) to inhibit the loss of fluoride from the ion conducting membrane when compared to an ion conducting membrane having the same construction except for the presence of cerium ions. The MEA also includes a first catalyst layer disposed on the first side of the ion conducting layer and a second catalyst layer disposed on the second side of the ion conduction layer. A first gasket is disposed between the first catalyst layer and the first side of the ion conducting membrane along the periphery of the second side. Similarly, a second gasket is interposed between the second catalyst layer and the second side of the ion conducting membrane along the periphery of the second side.

In another embodiment of the present invention a method of making the MEA set forth above is provided.

### BRIEF DESCRIPTION OF THE DRAWINGS

Exemplary embodiments of the present invention will become more fully understood from the detailed description and the accompanying drawings, wherein:

FIG. 1 is a schematic illustration of a fuel cell that incorporates a gas diffusion layer of one or more embodiments of the invention;

FIG. 2A is a schematic cross section of a membrane electrode assembly exhibiting improved fluoride retention;

FIG. 2B is a schematic cross section of a membrane electrode assembly exhibiting improved fluoride retention;

FIG. 3 is a top view of a gasket used in this membrane assembly; and

FIG. 4 provides plots of fluoride release rates versus time for fuel cells with and without gaskets.

### DETAILED DESCRIPTION OF EXEMPLARY EMBODIMENTS

Reference will now be made in detail to presently preferred compositions, embodiments and methods of the present invention, which constitute the best modes of practicing the invention presently known to the inventor. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

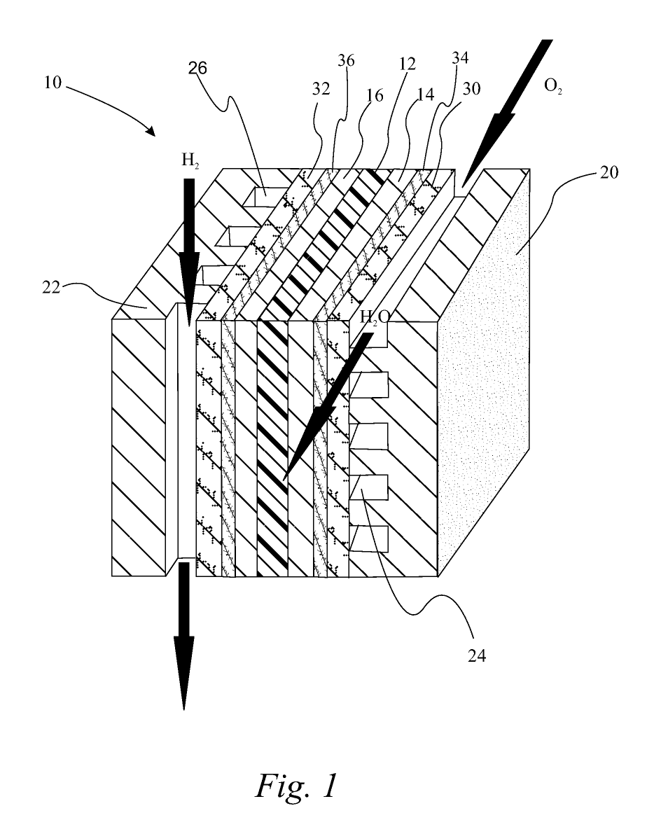

With reference to FIG. 1, a fuel cell that incorporates a membrane electrode assembly of an embodiment of the present invention is provided. PEM fuel cell 10 includes polymeric ion conductive membrane 12 disposed between first catalyst layer 14 and second catalyst layer 16. In a variation, first catalyst layer 14 is a cathode layer and second catalyst layer 16 is an anode layer. Collectively, polymeric ion conductive membrane 12, cathode catalyst layer 14, and anode catalyst layer 16 define a membrane electrode assembly (“MEA”). An ion conductive membrane includes an effective amount of a stabilization agent (e.g., cerium ions) to inhibit the loss of fluoride from the ion conducting membrane. Moreover, the MEA of the present embodiment includes peripheral gasketing between ion conductive layer 12 and the catalyst layers to maintain the beneficial effects of the stabilization agent (e.g., cerium ions) in reducing fluoride loss.

Fuel cell 10 also includes electrically conductive plates 20, 22 and gas channels 24 and 26. Gas diffusion layer 30 is interposed between electrically conductive plate 20 and first catalyst layer 14, and gas diffusion layer 32 is interposed between electrically conductive plate 22 and second catalyst layer 16. Optionally, gas diffusion layer 30 includes microporous layer 34 and gas diffusion layer 32 includes microporous layer 36.

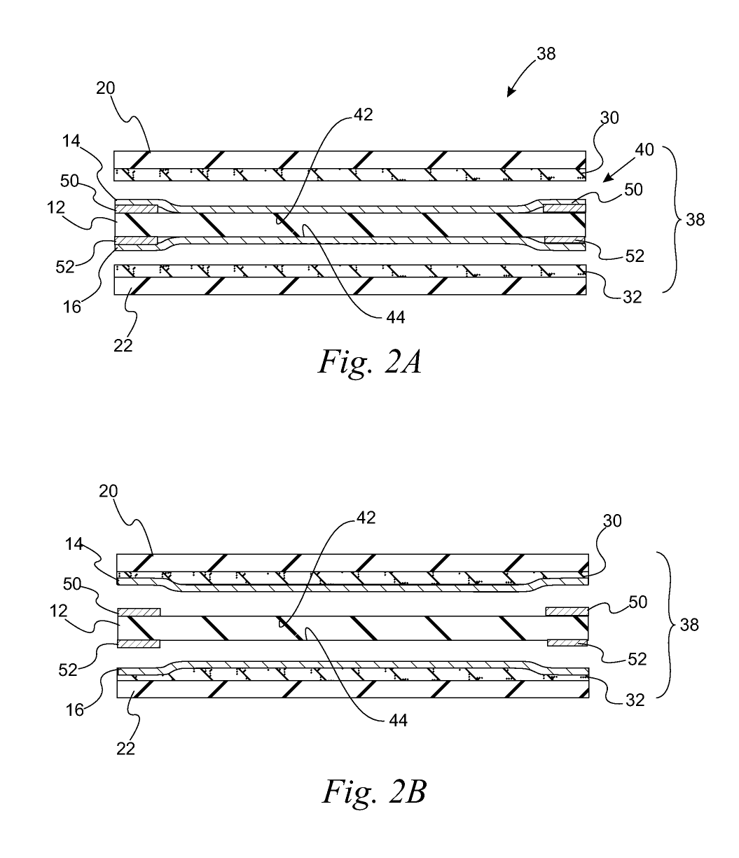

With reference to FIGS. 2A and 2B, illustrations of fuel cells with improved fluoride retention are provided. FIG. 2A is a schematic cross section of a fuel cell in which the catalyst layers are applied to an ion conducting layer. In the variation of FIG. 2A, fuel cell 38 includes membrane electrode assembly 40. Membrane electrode assembly 40 includes ion conductive membrane 12 having first side 42 and second side 44. As set forth above, the ion conductive membrane 12 includes an effective amount of a stabilization agent (e.g., cerium ions) to inhibit the loss of fluoride from the ion conductive membrane. First catalyst layer 14 is applied or adhered to first side 42 of ion conducting layer 12. First gasket 50 is interposed between the first catalyst layer 14 and first side 42 of ion conducting membrane 12. Second catalyst layer 16 is applied or adhered to second side 44 of the ion conduction layer. In a variation, second gasket 52 is interposed between second catalyst layer 16 and second side 44 of ion conducting membrane 12. FIG. 2B provides a variation in which first catalyst layer 14 is applied or adhered to gas diffusion layer 30 and second catalyst layer 16 is applied or adhered to gas diffusion layer 32.

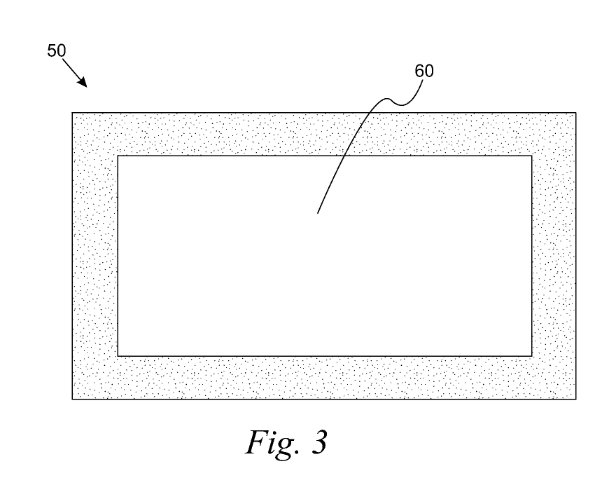

FIG. 3 provides a top view of a gasket used in this membrane assembly. In a variation of FIG. 3, gasket 50 defines central region 60 that allows contact between the catalyst layers and the ion conductive membrane while providing separation of ion conducting membrane 12 from catalyst layers 14 and 16 at or near the periphery. Gasket 52 is of a similar construction to that of gasket 50. In one variation, the gaskets each independently include a polymer. Examples of suitable polymers include, but are not limited to, polyimide, polyesters, and combinations thereof. In a refinement, gaskets 50, 52 have a thickness from about 2 to about 150 microns. In another refinement, gaskets 50, 52 have a thickness from about 20 to about 75 microns.

In a variation, gaskets 50, 52 each independently include a polymer. In general, useful polymers are stable under fuel cell operating conditions, electrically insulating, and impermeable to hydrogen gas. In a further refinement, the polymers are also imperable to oxygen gas. Examples of useful polymers for forming gaskets 50, 52 include, but are not limited to, polyimides, polyolefins (e.g., polyethylene naphthalate (PEN) and polyethylene terephthalate (PET)), and the like. A particularly useful material is the DuPont product Kapton® which is a polyimide.

As set forth above, the fuel cell of the present embodiment includes a first and a second catalyst layer. Typically, the first catalyst layer and the second catalyst layer each independently include a precious metal. In a variation, the first catalyst layer and the second catalyst layer each independently include a catalyst support. In a further refinement, the first catalyst layer and the second catalyst layer each independently include a catalyst in an amount from about 0.01 mg/cm² to about 0.8 mg/cm². In a further refinement, the first catalyst layer and the second catalyst layer each independently include a catalyst in an amount from about 0.05 mg/cm² to about 0.5 mg/cm². Preferred catalysts include metals, but are not limited to, platinum (Pt), palladium (Pd); and mixtures of metals Pt and molybdenum (Mo), Pt and cobalt (Co), Pt and ruthenium (Ru), Pt and nickel (Ni), and Pt and tin (Sn). Typically, such catalysts are impregnated onto a supports such as carbon or various metal-oxides. In another variation, the first catalyst layer and the second catalyst layer each independently include a stabilization agent (e.g., cerium ions). In a refinement, the stabilization agent (e.g., cerium ions) is diffusible into the ion conducting layer.

In a variation of the present embodiment, the fuel cells set forth above are characterized by a fluoride release rate under open circuit conditions at 95° C. and 50% relative humidity that is less than about 1×10⁻⁷ gF/cm²·h. In another variation, the fuel cells are characterized by fluoride release rates under open circuit conditions at 95° C. and 50% relative humidity is from about 1×10⁻⁶ gF/cm²·h to about 1×10⁻⁵ gF/cm²·h. In yet another variation, the fuels cells set forth above are characterized by SO₃H exchange levels that are from 0.1% to about 1 mol %.

In another embodiment, a method of making a fuel cell as set forth above is provided. The method of this embodiment includes a step of placing a first gasket over a first side of an ion conducting layer to form a first gasket/ion conducting layer combination. A first catalyst layer is then placed over the first gasket/ion conducting layer combination such that the first catalyst layer contacts a portion of the ion conducting layer and a portion of the first gasket. Characteristically, the first catalyst layer includes a stabilization agent (e.g., cerium ions) that is diffusible into the ion conducting layer. A second catalyst layer is then placed over a second side of the ion conducting layer. In a variation, a second gasket is placed over the second side of the ion conducting layer prior to placement of the second catalyst layer over the second side of the ion conducting layer. In a refinement, the second catalyst layer includes a stabilization agent (e.g., cerium ions) that is diffusible into the ion conducting layer. In a refinement, the stabilization agent is present in an amount of about 0.01 weight percent to about 5 weight percent of the weight of the catalyst layer (i.e., first catalyst layer or second catalyst layer) in which it is included. In another refinement, the stabilization agent is present in an amount of about 0.1 weight percent to about 4 weight percent of the weight of the catalyst layer (i.e., first catalyst layer or second catalyst layer) in which it is included. In still another refinement, the stabilization agent is present in an amount of about 0.5 weight percent to about 3 weight percent of the weight of the catalyst layer (i.e., first catalyst layer or second catalyst layer) in which it is included. Optional gas diffusion layers may be placed over the first and second catalyst layer. The fuel cell is completed by placement of the electrically conductive plates on each side.

In yet another embodiment, a method of making a fuel cell as set forth above is provided. The method of this embodiment includes a step of placing a first gasket over a first side of an ion conducting layer to form a first gasket/ion conducting layer combination. A first catalyst layer/gas diffusion layer combination is then placed over the first gasket/ion conducting layer combination such that the first catalyst layer contacts a portion of the ion conducting layer and a portion of the first gasket. Characteristically, the first catalyst layer includes a stabilization agent (e.g., cerium ions) that is diffusible into the ion conducting layer. A second catalyst layer/gas diffusion layer combination is then placed over a second side of the ion conducting layer. In a variation, a second gasket is placed over the second side of the ion conducting layer prior to placement of the second catalyst/gas diffusion layer combination over the second side of the ion conducting layer. In a refinement, the second catalyst layer includes cerium ions that are diffusible into the ion conducting layer. In a refinement, the stabilization agent is present in an amount of about 0.01 weight percent to about 5 weight percent of the weight of the catalyst layer (i.e., first catalyst layer or second catalyst layer) in which it is included. In another refinement, the stabilization agent is present in an amount of about 0.1 weight percent to about 4 weight percent of the weight of the catalyst layer (i.e., first catalyst layer or second catalyst layer) in which it is included. In still another refinement, the stabilization agent is present in an amount of about 0.5 weight percent to about 3 weight percent of the weight of the catalyst layer (i.e., first catalyst layer or second catalyst layer) in which it is included. The fuel cell is completed by placement of electrically conductive plates over the first and second catalyst/gas diffusion layer combination.

In the variation embodiments and variations set forth above, the stabilization agent comprises cerium ions and in particular Ce3+ ions. In another variation, the stabilization agent includes a compound selected from the group consisting of CeO₂, MnO₂, Ce(III) containing compounds, Ce(IV) containing compounds, Mn(II) containing compounds, Mn(IV) containing compounds, and combinations thereof. In still another variation, the stabilization agent comprises a compound selected from the group consisting of CeO₂ nanoparticles, MnO₂ nanoparticles, and combinations thereof.

The following examples illustrate the various embodiments of the present invention. Those skilled in the art will recognize many variations that are within the spirit of the present invention and scope of the claims.

### Catalyst Ink Preparation

To 55.5 g of a magnetically stirred ethanol/water solution of perfluorosulfonic acid ionomer (28% solids, 15.5 g ionomer, EW=910 g/mol, 17.1 mmol SO₃H) is added 172 mg of Ce₂(CO₃)₃.8H₂O (0.57 mmol Ce³⁺). Carbon dioxide evolution occurs as the temperature of the solution is raised to 40° C. for one hour and then allowed to stir overnight. The ionomer solution is added to 34.2 g of a catalyst powder in which Pt (45.6 wt. %) is supported on a carbon nanoparticle carrier (ionomer/carbon=0.84). The resulting mixture is milled for 72 hours to prepare the catalyst ink for coating. The catalyst ink is coated on an ePTFE decal using a coating bar and dried at 80° C. for five minutes. The large catalyst decal is die cut to 50 cm² decals for membrane electrode assembly. Using this ink making procedure the catalyst decal contains 0.1 mg (0.7 μmol) Ce³⁺. Unmitigated decals are prepared using a virtually identical procedure which omits the addition of the cerium salt.

### MEA Preparation

Unsubgasketed membrane electrode assemblies (MEAs) are prepared by hot pressing two 50 cm² catalyst decals to a 100 cm² Nafion® 212CS 50 μm (EW=1100) membrane for four minutes under a force 4000 pounds (300 psi). Based on mass of catalyst transferred, the nominal Pt coverage is determined to be 0.4 mg/cm². The amount of SO₃H contained within a 100 cm² sample of membrane is 0.91 mmol. The level of SO₃H exchange level in the membrane is determined by total of Ce³⁺ contained within both decals. The SO₃H exchange levels within the membrane when one or two cerium-loaded decals are used for MEA preparation are 0.24 and 0.48 mol %, respectively.

Subgasketed MEAs are prepared in a similar manner except that a 7.5 μm thick Kapton® polyimide film with a square window opening of approximately 44 cm² is laid on each side of the membrane before hot pressing the decal. The 50 cm² decals are applied over the square opening in the Kapton® film. The windows on the anode and cathode sides of the membrane can be of the same dimension or they can differ in size, but both windows must be smaller than the catalyst decal area. A typical MEA configuration employs anode and cathode active areas of 38 and 44 cm², respectively.

### Chemical Durability Testing

The membrane electrode assembly chemical durability is evaluated by monitoring fluoride release rates (FRR) during operation under open circuit conditions at 95° C. and 50% relative humidity for both anode and cathode. Fluoride release rates of membrane electrode assemblies of the present invention are evaluated in comparison with MEAs prepared without electrode subgaskets.

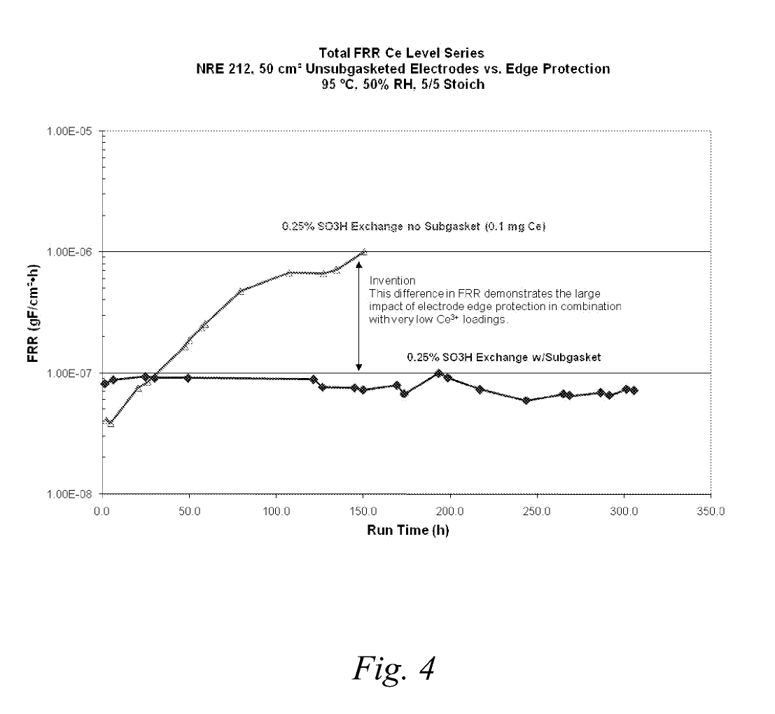

FIG. 4 provide plots of fluoride release rates illustrating the impact of the gasketing technology set forth above. The FRRs of two MEAs containing identical levels of cerium (0.24 mol %) are shown. The reference sample has no electrode edge subgaskets while the inventive example has subgaskets on both the anode and cathode electrodes with active areas of 38 and 44 cm², respectively. During the 95° C. OCV test, the FRR of the unsubgasketed reference MEA rises steadily over 150 hours to reach a value of 1×10⁻⁶ gF/cm²·h. The FRR of the inventive MEA remains at a constant value of about 8×10⁻⁸ gF/cm²·h during over 300 hours of testing. Thus, the subgasketing technology reduces the FRR by more than an order of magnitude and thereby increases MEA lifetime.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A fuel cell comprising:
an ion conductive membrane having a first side and a second side, the ion conducting membrane having an effective amount of cerium ions to inhibit the loss of fluoride from the ion conducting membrane;
a first catalyst layer disposed on the first side of the ion conducting layer;
a first gasket interposed between the first catalyst layer and the first side of the ion conducting membrane;
a second catalyst layer disposed on the second side of the ion conduction membrane; and
a second gasket interposed between the second catalyst layer and the second side of the ion conducting membrane.

2. The fuel cell of claim 1 wherein the first gasket and the second gasket each independently include a polymer.

3. The fuel cell of claim 1 wherein the first gasket and the second gasket each independently include a polymer selected from the group consisting of polyimide, polyesters, and combinations thereof.

4. The fuel cell of claim 1 wherein the first catalyst layer and the second catalyst layer are each independently adhered to the ion conducting membrane.

5. The fuel cell of claim 1 further comprising a first gas diffusion layer disposed over the first catalyst layer and a second gas diffusion layer disposed over the second catalyst layer.

6. The fuel cell of claim 5 wherein the first catalyst layer is adhered to the first diffusion layer and the second catalyst layer is adhered to the second gas diffusion layer.

7. The fuel cell of claim 2 wherein fluoride release rates under open circuit conditions at 95° C. and 50% relative humidity is less than about 1×10⁻⁷ gF/cm²·h.

8. The fuel cell of claim 2 wherein fluoride release rates under open circuit conditions at 95° C. and 50% relative humidity is from about 1×10⁻⁶ gF/cm²·h to about 1×10⁻⁵ gF/cm²·h.

9. The fuel cell of claim 1 wherein the first catalyst layer and the second catalyst layer each independently include a precious metal.

10. The fuel cell of claim 9 wherein the first catalyst layer and the second catalyst layer each independently include a catalyst support.

11. The fuel cell of claim 9 wherein the first catalyst layer and the second catalyst layer each independently include a catalyst in an amount from about 0.1 mg/cm² to about 0.8 mg/cm².

12. The fuel cell of claim 9 wherein the first catalyst layer and the second catalyst layer each independently include cerium ions.

13. The fuel cell of claim 11 wherein the first or second catalyst layer includes cerium ions that are diffusible into the ion conducting layer.

14. The fuel cell of claim 1 wherein the SO₃H exchange levels are from 0.1% to about 1 mol %.

15. A method of making a membrane electrode assembly, the method comprising:
a) placing a first gasket over a first side of an ion conducting layer to form a first gasket/ion conducting layer combination;
b) placing a first catalyst layer over the first gasket/ion conducting layer combination such that the first catalyst layer contacts a portion of the ion conducting layer and a portion of the first gasket, the first catalyst layer including cerium ions that are diffusible into the ion conducting layer; and
c) placing a second catalyst layer over a second side of the ion conducting layer.

16. The method of claim 15 wherein a second gasket is placed over the second side of the ion conducting layer prior to step c).

17. The method of claim 16 wherein the second catalyst layer includes cerium ions that are diffusible into the ion conducting layer.

18. A fuel cell comprising:
an ion conductive membrane having a first side and a second side, the ion conducting membrane having an effective amount of stabilization agent to inhibit the loss of fluoride from the ion conducting membrane, the stabilization agent selected from the group consisting of cerium-containing compounds, manganese-containing compounds, and combinations thereof;
a first catalyst layer disposed on the first side of the ion conducting membrane;
a first gasket interposed between the first catalyst layer and the first side of the ion conducting membrane;
a second catalyst layer disposed on the second side of the ion conduction membrane; and
a second gasket interposed between the second catalyst layer and the second side of the ion conducting membrane.

19. The fuel cell of claim 1 wherein the stabilization agent comprises a compound selected from the group consisting of CeO₂, MnO₂, Ce(III) containing compounds, Ce(IV) containing compounds, Mn(II) containing compounds, Mn(IV) containing compounds, and combinations thereof.

20. The fuel cell of claim 1 wherein the stabilization agent comprises a compound selected from the group consisting of CeO₂ nanoparticles, MnO₂ nanoparticles, and combinations thereof.
